(19) United States
(12) Patent Application Publication
(10) Pub. No.: US 2005/0200990 A1
(43) Pub. Date: Sep. 15, 2005

(54) Master substrate, apparatus and method for magnetic transfer

(75) Inventor: Naoto Fujiwara, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/075,888

(22) Filed: Mar. 10, 2005

(30) Foreign Application Priority Data
Mar. 10, 2004 (JP) 066482/2004

(51) Int. Cl. G11B 5/86; G03C 5/00

(52) U.S. Cl. 360/17; 430/320

(57) ABSTRACT

Deformations (distortion/warp) of a master base plate developed during manufacturing are regulated to ensure close contact with a slave medium and quality of magnetic transfer. The master base plate is formed by the following steps. A metal is laminated through electroforming or the like on an irregular pattern corresponding to information to be transferred formed on an original disk. The metal is formed into a disk having a predetermined thickness, which is then peeled off the original disk. The amount of distortion of the master base plate along one rotation at any equidistance radius is less than or equal to 70 μm. Preferably, in the amount of distortion along one rotation at any equidistance radius of the master base plate, the ratio of distortion components beyond secondary distortion component is less than or equal to 20%, and warp is less than or equal to 150 μm.

### BACKGROUND OF THE INVENTION

1. Field of the Invention

The present invention relates to a master substrate, apparatus and method for magnetic transfer, in which information carried by the master substrate is transferred to a slave medium by magnetic transfer.

2. Description of the Related Art

The present invention is applied to magnetic transfer, in which a magnetic pattern corresponding to information carried by a master substrate is transferred to a slave medium having a magnetic recording section. The master substrate has at least a magnetic layer on the outermost layer, and a transfer pattern representing, for example, a servo signal or the like, is formed in an irregular pattern (patterned master) . The magnetic transfer from the master substrate to the slave medium is implemented by placing the master substrate and the slave medium together in close contact with each other and applying a transferring magnetic field thereto.

When the slave medium is a disk-shaped medium, such as a hard disk or a high-density flexible disk, the master substrate is also shaped in a disk having a transfer pattern formed concentrically. The master substrate or substrates are placed on either or both sides of the slave medium in close contact, and a transferring magnetic field is applied thereto by arranging a magnetic field application device of electromagnet or permanent magnet on either or both sides.

One type of such master substrate is proposed as described, for example, in U.S. Pat. No. 6,759,183. The master substrate described above has an irregular pattern corresponding to an information signal formed on the surface of the substrate with a magnetic layer coated on the irregular pattern.

The present invention is applied to a master substrate to be produced, for example, by the following steps. First, an electron-beam resist or a photoresist is coated on a Si base plate, a transfer pattern is pattern-exposed by an electron beam, light beam, or the like, and the pattern-exposed base plate is processed to obtain an original master having an irregular pattern created by the resist. Then, a conductive layer is formed, for example, by sputtering on the irregular pattern of the original master, which is further processed by Ni electroforming to create a metal disk having a predetermined thickness (electroformed Ni layer). Then, the metal disk is peeled off the original master and punched out into a predetermined size to obtain a master base plate (replica). Alternatively, the replicated master base plate before punched out is used as a original master, and electroforming is repeated to create a metal disk having a predetermined thickness, which is peeled off the original master and punched out into a predetermined size to obtain a master base plate (replica). Thereafter, a magnetic layer is provided on the surface of the irregular pattern of the master base plate to obtain a master substrate having a transfer pattern of magnetic layer.

The magnetic transfer using the master substrate produced in the manner described above is a magnetic transfer which is implemented by placing the master substrate and a slave medium of magnetic recording medium, such as a hard disk or a flexible disk, together in close contact with each other and applying an external magnetic field thereto, thereby a magnetic signal corresponding to the transfer pattern is transferred and recorded on the slave medium.

The stamper creation technology using Ni electroforming is widely used for manufacturing optical disks and the like. Generally, in the manufacture of optical disks, a disk base plate made of resin is formed by an injection molding machine based on a master base plate (stamper), so that a slight distortion (deformation) of the master base plate may be eliminated by the pressure applied at the time of the injection molding. On the other hand, in the magnetic transfer, the intervals of the protruding and recessed portions of the pattern are narrower than those of the optical disk. The pattern forming unit may be less than 300 nm, for example, 50 nm or less, so that higher precision is required.

In order to transfer a quality signal in the magnetic transfer described above, it is important to place the master substrate and slave medium together so that they overlap closely and uniformly with each other without any gap between them. For this reason, various measures have been taken, including an increased contact pressure, air exhaustion for eliminating air pockets between the contact surfaces arising from the vacuum suction, and the like.

But, an increased contact pressure may damage or deform the pattern on the master substrate, causing degradation in the durability of the master substrate. Application of an extraordinary high pressure is undesirable for the master substrate of magnetic transfer which is expensive, and therefore required of long-standing durability.

The master substrate having the base plate formed of a Si base plate has smaller amounts of warp and distortion. But, forming a pattern of magnetic material is complicated/troublesome and time-consuming, resulting in high manufacturing costs. On the other hand, the master substrate using the master base plate formed by Ni electroforming based on the original master described above or the master base plate obtained by further replicating the master base plate formed by Ni electroforming is more readily manufactured. In addition, a plurality of master base plates may be replicated from a single original master, which is advantageous in many ways including manufacturing costs and is suited for practical use.

But, the master substrate formed of a master base plate created by forming a metal disk layer using the original master and peeling it off the original master does not necessarily have a flat surface. It is warped or distorted due to deformations developed in the metal disk peeling process off the original master and punching out process of the disk into a predetermined size.

A warped or distorted master base plate or master substrate causes low contact with the slave medium, causing a gap to be developed between them. In particular, where the bit interval is less than 300 nm, the amount of the gap described above has significant impact on the transfer characteristics. In addition, the surface properties of the master substrate and slave medium, thickness of the protection layer provided on the magnetic layer for increasing the durability, and the like may also influence the transfer characteristics. Thus, basically it is important to reduce the amounts of warp and distortion of the master substrate.

### SUMMARY OF THE INVENTION

The present invention has been developed in view of the circumstances described above, and it is an object of the present invention to provide a magnetic transfer master substrate, which is produced by regulating deformations (distortion/warp) arising from the force and the like when the metal disk is peeled off the original disk to ensure close contact with a slave medium. It is a further object of the present invention to provide a magnetic transfer apparatus and method using the master substrate described above.

A magnetic transfer master substrate of the present invention comprises:

a master base plate made of a metal having thereon an irregular pattern corresponding to information to be transferred; and

a magnetic layer formed on the irregular pattern, wherein the amount of distortion along one rotation at any equidistance radius of the master base plate is less than or equal to 70 μm.

Preferably, the amount of distortion described above is less than or equal to 30 μm, and more preferably less than or equal to 10 μm.

In particular, for the master base plate described above, it is desirable that in the amount of distortion along one rotation at any equidistance radius of the master base plate, the ratio of distortion components beyond secondary distortion component is less than or equal to 20% (preferably, less than or equal to 10%, and more preferably, less than or equal to 5%). In addition, it is desirable that the amount of warp of the master base plate is less than or equal to 150 μm (preferably, less than or equal to 80 μm, and more preferably, less than or equal to 40 μm). Preferably, the master base plate comprises an electroformed Ni layer.

The original master described above may be an original master made of a metal formed by administering electroforming on an irregular pattern formed through pattern exposure on a photoresist to obtain a metal form, and peeling the metal form off the irregular pattern.

It is noted that the “amount of distortion” described above is defined by the difference between the highest and lowest positions in displacement along one rotation at an equidistance radius of the master base plate. The “amount of warp” is defined by the difference in displacement between concentric tracks having the highest and lowest values when displacement values for respective tracks are averaged in the warp deformation in which the height of the master base plate in the outer circumferential area differs from that of the inner circumferential area.

A magnetic transfer apparatus of the present invention employs the magnetic transfer master substrate of the present invention, wherein the information carried by the master substrate is transferred to a slave medium, which is a magnetic recording medium, by placing the master substrate and the magnetic recording medium together such that the surface of the master medium contacts closely with the magnetic recording medium, and applying a transferring magnetic field thereto.

A magnetic transfer method of the present invention uses the magnetic transfer master substrate and magnetic transfer apparatus of the present invention, wherein information carried by the master substrate is transferred to a slave medium, which is a magnetic recording medium, by placing the magnetic recording medium and the master substrate together in close contact with each other, and applying a transferring magnetic field thereto.

According to the master substrate of the present invention described above, the amount of distortion along one rotation at any equidistance radius of the master base plate is less than or equal to 70 μm, which provides sufficient flatness to ensure close contact with the slave medium at the time of magnetic transfer. This reduces variations in signal output (variations in signal amplitude, i.e., modulation) per a single track of a signal transferred and recorded on the slave medium to less than or equal to 5%. Thus, the master substrate of the present invention enables quality information transfer which is sufficient, for example, to provide a servo signal that maintains good servo following capability.

Further, if the amount of distortion along one rotation at any equidistance radius of the master base plate is less than or equal to 70 μm, and the ratio of high-order distortion components beyond secondary distortion component is less than or equal to 20%, the distortion is reduced by the deformation of the master base plate due to the pressure applied thereto when the master substrate is placed in close contact with the slave medium, thus the close contact with the slave medium is ensured.

Still further, if the amount of warp of the master base plate is less than or equal to 150 μm, the warp is reduced also by the deformation of the master base plate due to the pressure applied thereto when the master substrate is placed in close contact with the slave medium, thus the close contact with the slave medium is ensured.

### BRIEF DESCRIPTION OF THE DRAWINGS

FIG. 1 is a schematic partial cross sectional view of the magnetic transfer master substrate according to an embodiment of the present invention.

FIG. 2 is a plan view of the master base plate of the master substrate shown in FIG. 1.

FIG. 3A is a drawing illustrating the process flow of producing the master base plate according to an embodiment of the present invention.

FIG. 3B is a drawing illustrating the process flow of producing the master base plate according to an embodiment of the present invention.

FIG. 3C is a drawing illustrating the process flow of producing the master base plate according to an embodiment of the present invention.

FIG. 3D is a drawing illustrating the process flow of producing the master base plate according to an embodiment of the present invention.

FIG. 3E is a drawing illustrating the process flow of producing the master base plate according to an embodiment of the present invention.

FIG. 4 is a graph illustrating measurement results of displacement in height along one rotation at an equidistance radius of the master base plate of Example 1.

### DESCRIPTION OF THE PREFERRED EMBODIMENTS

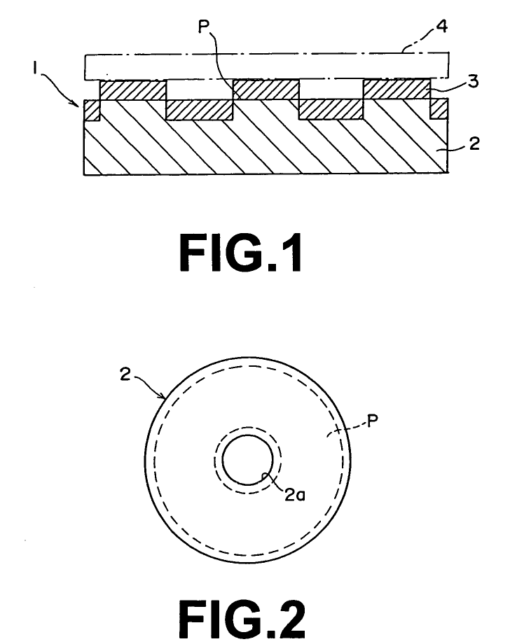

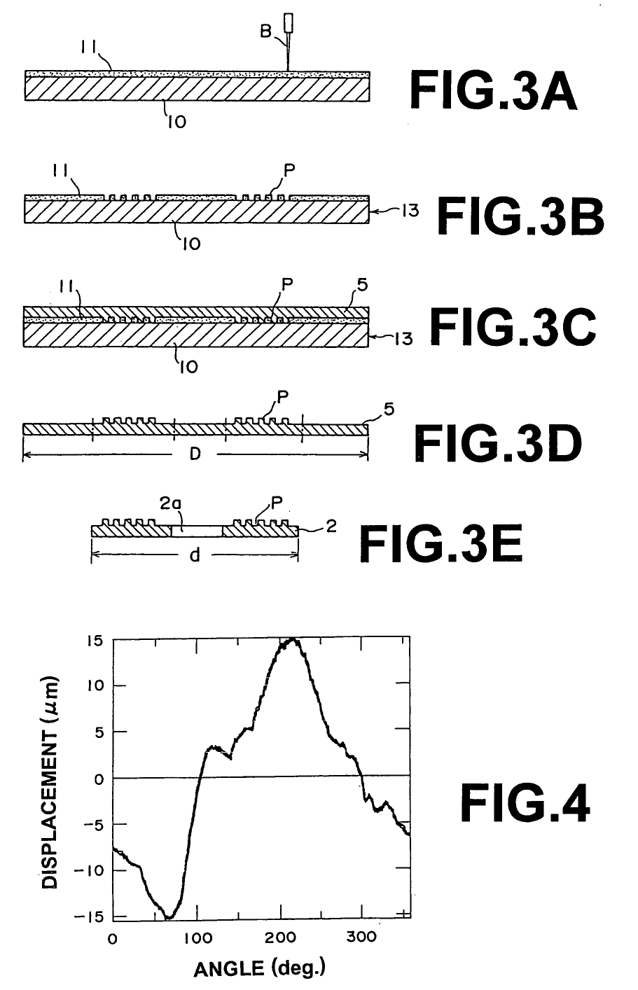

Hereinafter, embodiments of the present invention will be described in detail with reference to accompanying drawings. FIG. 1 is a schematic partial cross sectional view of the magnetic transfer master substrate according to an embodiment of the present invention. FIG. 2 is a plan view of the master base plate of the master substrate shown in FIG. 1. FIGS. 3A to 3E are drawings illustrating the process flow of producing the master base plate according to an embodiment of the present invention. It is noted that these drawings are schematic drawings, and components and elements are not necessarily drawn to scale.

A master substrate 1 for magnetic transfer shown in FIG. 1 comprises a master base plate 2 made of a metal and a magnetic layer 3. The master base plate 2 has thereon a microscopic irregular pattern P (transfer pattern) corresponding to information to be transferred, and the magnetic layer 3 is coated thereon.

The master base plate 2 is made of Ni, which is produced, for example, by electroforming, and is shaped in disk having a central hole 2a as shown in FIG. 2. The irregular pattern P is formed on the annular area excluding the inner and outer circumferential areas on one side (information carrying surface) of the master base plate 2. The master base plate 2 is produced by the following steps, the details of which will be described later. A metal disk having a predetermined thickness is formed, for example, by electroforming on an original master having an irregular pattern corresponding to information to be transferred. Then, the metal disk formed in the manner described above is peeled off the original master and punched out into a disk having a predetermined outer diameter with a central hole 2a of a predetermined size. The amount of distortion along one rotation at any equidistance radius of the master base plate is less than or equal to 70 μm (preferably less than or equal to 30 μm, and more preferably, less than or equal to 10 μm). In particular, in the amount of distortion along one rotation at any equidistance radius of the master base plate 2, the ratio of distortion components beyond secondary distortion component is less than or equal to 20% (preferably, less than or equal to 10%, and more preferably, less than or equal to 5%). In addition, the amount of warp of the master base plate 2 is less than or equal to 150 μm (preferably, less than or equal to 80 μm, and more preferably, less than or equal to 40 μm).

As shown in FIG. 1, the magnetic transfer is implemented by placing the master substrate 1 and a slave medium 4, which receives magnetic transfer and is indicated by a dotted line in the drawing, together so that the surface of the magnetic layer 3 (irregular pattern) of the substrate 1 and the slave medium 4 contact closely with each other, and applying a transferring magnetic field thereto. It is noted that the slave medium 4 has been given initial magnetization in advance in either of a longitudinal or vertical direction, and the transferring magnetic field is applied in the direction which is opposite to the direction of the initial magnetization.

The transferring magnetic field applied at the time of the magnetic transfer described above is drawn into the protruding portions of the magnetic layer 3 which is in close contact with the slave medium 4 in the irregular pattern of the master substrate 1. If the magnetic transfer is a longitudinal recording, the initial magnetization of the protruding portions described above is not reversed and the initial magnetization of other portions is reversed. If the magnetic transfer is a vertical recording, the initial magnetization of the protruding portions described above is reversed and the initial magnetization of other portions is not reversed. As a result, a magnetic pattern corresponding to the irregular pattern of the master substrate 1 is transferred and recorded on the magnetic recording layer of the slave medium 4. Preferably, the height of the protruding portions of the magnetic layer 3 is in the range of 20 to 600 nm, and more preferably in the range of 30 to 300 nm.

It is noted that if the irregular pattern of the magnetic layer 3 is a negative pattern, which is a reversed irregular pattern of a positive pattern, the identical magnetic pattern is transferred and recorded on the magnetic layer 3 of the slave medium 4 by reversing the directions of the initial magnetization and the transferring magnetic field.

The magnetic transfer apparatus is not shown in the drawings, but it comprises a contacting means for placing the master substrate 1 and slave medium 4 in close contact with each other, a magnetic field applying means for applying the transferring magnetic field, and the like, and is used for implementing the magnetic transfer method described above by replacing the slave medium 4 one after another.

Hereinafter, a manufacturing method of the master base plate 2 according to an embodiment will be described with reference to FIGS. 3A to 3E.

First, as shown in FIG. 3A, a resist coat 11 is formed on a primitive plate 10 of silicon wafer (or glass plate/quartz plate) having a flat and clean surface by spin coating an electron beam resist liquid, after pretreatment of the surface including preparation of a contact layer, and baked. Then, a desired pattern is pattern-exposed on the resist coat 11 using an electron beam exposure system having a high accurate rotary stage or x-y stage (not shown), in which an electron beam B modulated in accordance with a servo signal or the like is irradiated on the primitive plate 10 mounted on the stage. Thereafter, as shown in FIG. 3B, the resist coat 11 is processed to remove the exposed portions and to form a desired irregular pattern P having a desired thickness with the remaining resist coat 11. Then, a Ni conductive layer (not shown) is provided on the irregular pattern to produce an original disk 13 that enables electroforming.

Then, as shown in FIG. 3C, a metal disk 5 (electroformed layer) of desired thickness made of Ni is formed by electroforming using an electroforming system. Thereafter, the metal disk 5 is peeled off the original disk 13 and washed after residual resist coat 11 is removed to obtain a metal disk 5 having the reversed irregular pattern P as shown in FIG. 3D. It is noted that the electroforming described above is performed under optimum conditions provided by adjusting the liquid concentration, pH, application of electric current, liquid temperature, and the like, so that distortion of the electroformed layer is minimized.

Then, the metal disk 5 described above having an outer diameter D is punched out at inner and outer diameters to obtain a master base plate 2 having outer diameter d as shown in FIG. 3E.

It is noted that a distortion eliminating process may be performed on the master base plate 2 produced in the manner described above for eliminating deformations (distortion/warp) received when the metal disk 5 is peeled off the original disk 13 and punched out in order to flatten the master base plate 2. Such distortion eliminating process described above may be, for example, annealing in which the master base plate 2 is placed on a flat plate within an electric furnace and heat-treated for 30 minutes to 2 hours under an atmosphere of 200 to 300 degrees Celsius, for example 250 degrees Celsius×1 hour, and to eliminate deformations by eliminating internal stress.

Further, in the manufacturing process described above, the metal disk 5 is produced with the outer diameter D which is, for example, 1.7 times greater than the outer diameter d of the master base plate 2 (D≧1.7d) and the circumferential area is greater than the transfer pattern area. Thus, when the metal disk 5 is peeled off the original disk 13, the action of force exerted on the area of transfer pattern P through the action of force exerted on the circumferential area is equalized, thereby deformations of the metal disk 5 is reduced and the flatness is improved.

Following the manufacturing process described above, a magnetic layer 3 (not shown) is formed on the surface of the irregular pattern P of the master base plate 2 by sputtering. In addition a protection layer may also be formed as required. In this way, the master substrate 1 is produced.

The master base plate may be produced through an alternative process, in which electroforming is performed on the original disk 13 to produce a second original disk, and another electroforming is perform using the second original disk to produce a metal disk having a reversed irregular pattern, which is then punched out into a predetermined size. The master base plate may also be produced through the following still another alternative process. Namely, a third original disk is produced by performing electroforming on the second original disk, or by pressing resin solution on the second original disk and solidifying it. Then, electroforming is performed on the third original disk to produce a metal disk having a further reversed irregular pattern. Finally, the metal disk is peeled off to produce a master base plate. A plurality of the metal disk may be produced by repeated use of the second or third original disk. It is noted that, in the manufacturing process of the original disk 13, after the resist coat 11 is exposed and processed, an etching process may be performed to form an irregular pattern on the surface of the primitive silicon wafer 10 before removing the resist coat 11. Then, Ni conductive layer is formed on the irregular pattern created by the etching, and the original disk 13 having an irregular pattern may be produced by performing electroforming in the same manner as described in FIG. 3C.

In the FIGS. 3A to 3E, rear faces of the original disk 13 and metal disk 5 are illustrated as flat surfaces. But even if irregular patterns are formed on the rear faces, which reflect the irregular patterns on the front faces, it does not pose any problem for forming the master substrate 1. These rear faces are flattened by grinding as required.

The magnetic layer 3 is formed of magnetic materials by coating methods, such as vacuum coating methods including vacuum evaporation, sputtering, and ion plating, or galvanizing methods including electroforming. As for the magnetic materials, the following may be used. Namely, Co, Co alloys (CoNi, CoNiZr, CoNbTaZr, and the like), Fe, Fe alloys (FeCo, FeCoNi, FeNiMo, FeAlSi, FeAl, FeTaN), Ni, and Ni alloy (NiFe) may be used. Particularly, FeCo and FeCoNi are preferable. Preferably, the thickness of the magnetic layer 3 is in the range of 50 nm to 500 nm, and more preferably, in the range of 50 nm to 300 nm.

Preferably, a protective coating of diamond-like carbon (DLC), sputtered carbon, or the like is provided on the irregular pattern of the magnetic layer 3. In addition, a lubricant layer maybe provided. More preferably, a DLC film of 5 to 30 nm thickness and lubricant layer are provided as the protective coating. The lubricant agent may prevent abrasion due to friction when misalignment that may arise in the process of making contact with the slave medium 4 is corrected and improve durability.

As for the slave medium 4, a disk-shaped magnetic recording medium, such as a hard disk or a high-density flexible disk having a magnetic layer formed on either or both sides is used. The magnetic recording section of the medium is formed of a coated type magnetic recording layer or a metallic film type magnetic recording layer. As for the magnetic materials for the metallic film type magnetic recording layer, the following may be used. Namely, Co, Co alloys (CoPtCr, CoCr, CoPtCrTa, CoPtCrNbTa, CoCrB, CoNi, and the like), Fe, and Fe alloys (FeCo, FePt, FeCoNi) may be used. Magnetic materials having high flux density and magnetic anisotropy direction which is the same as that of the applied magnetic field (longitudinal direction when longitudinal recording, and vertical direction when vertical recording) are preferable for clear magnetic transfer. Preferably, a nonmagnetic foundation layer is provided under the magnetic material (on the substrate side) in order to provide required magnetic anisotropy. The nonmagnetic material of the foundation layer and the magnetic material of the magnetic layer need to have the same crystalline structure and lattice constant. For this reason, Cr, CrTi, CoCr, CrTa, CrMo, NiAl, Ru, and the like are used.

In the case of longitudinal recording, the magnetic field applying means for applying initial magnetic field and transferring magnetic field comprises, for example, ring type electromagnet devices, each made of a core having a gap that extends in the radial direction of the slave medium 4 with a coil wound thereon. One of the electromagnets is placed on the upper side and the other is placed on the lower side, and transferring magnetic fields generated in the same direction on both sides, which is parallel to the direction of the tracks, are applied from both sides. The transferring magnetic fields are applied by the magnetic field applying means with a closely contacted body of the master substrate 1 and slave medium 4 being rotated. Alternatively, the magnetic field applying means may be arranged such that it rotates around the closely contacted body. The magnetic field applying means may be disposed only on one side, and a permanent magnet may be disposed on either or both sides.

In the case of vertical recording, the magnetic field applying means comprises electromagnets or permanent magnets having different polarities with each other, one of which is disposed on the upper side of the closely contacted body of the master substrate 1 and slave medium 4 and other of which is disposed on the lower side thereof, and magnetic field is generated and applied in vertical direction. If the magnetic field applying means is a means for applying magnetic field partially, the entire magnetic transfer is implemented by moving the closely contacted body of the master substrate 1 and slave medium 4 or the magnetic field.

In the master base plate 2 produced in the manner described above, the amount of distortion along one rotation at any equidistance radius of the master base plate is less than or equal to 70 μm. Preferably, in the amount of distortion described above, the ratio of distortion components beyond secondary distortion component is less than or equal to 20%, and the amount of warp is less than or equal to 150 μm. In this way, flatness is ensured for the master base plate 2, and the master substrate 1 that uses the master base plate 2 may improve the contact with the slave medium 4 at the time of magnetic transfer, thereby satisfactory magnetic transfer without variations in the transferred signal may be implemented.

Hereinafter, evaluation test results of the magnetic transfers using the master substrates of the present invention described above will be described. In conducting the test, three examples and three comparative examples of the master base plate were created under different manufacturing conditions, including electroforming and peeling off conditions. Then, the amount of distortion, amount of warp, and ratio of high-order distortion components were measured. Thereafter, magnetic transfers were performed using master substrates having the master base plates described above to measure and evaluate modulation. The results are shown in Table 1 below. In addition, FIG. 4 shows measurement results of the displacement in height along one rotation at an equidistance radius of Example 1.

The amount of distortion for each master base plate described above was measured in the following manner. The master base plate was fixed on a spindle motor at the inner diameter of 25 mm and rotated at 10 rpm. Maintaining this state, amounts of displacement along one rotation at 30 mm radius in the direction perpendicular to the surface of the master base plate were measured using a laser displacement sensor (available from KEYENCE Corporation, LC-2430 displacement sensor), which were inputted to a digital oscilloscope to obtain a waveform of the displacement. The difference between the maximum and minimum values of the displacement was deemed as the amount of distortion (except for a primary component caused by chucking) . In addition, frequency analysis (FFT conversion) was conducted for the displacement data of one rotation inputted to the oscilloscope to obtain the frequency components.

Warp means deformation in which the height of the master base plate in the outer circumferential area differs from that of the inner circumferential area, even when no distortion is observed along one rotation at any equidistance radius, i.e., along a single track. One such example is a spherical deformation. The amount of warp was determined by the difference in displacement values between concentric tracks having the highest and lowest values when displacement values for respective tracks were averaged in the distortion measurement described above.

In the measurement of the amount of distortion shown in FIG. 4, the displacement in height along one rotation is predominated by the primary component, which goes up once and then does down. The maximum and minimum values of the displacement in height are +15 μm and −15.5 μm respectively, and the amount of distortion is 30.5 μm. In order to examine the amplitude of periodic components of the height displacement obtained, fitting operation was performed using the following formula.
Amplitude (θ)=A+B1×sin(θ+C1)+B2×sin(2θ+C2)+B3×sin(3θ+C3)+B4×sin(4θ+C4)

Where, θ: angle; A, B1 to B4, C1 to C4: arbitrary coefficients (real numbers)

The amplitudes of the periodic components of Example 1 obtain by the fitting are: B1=11.7, B2=1.7, B3=2.3 and B4=2.0. Then, in order to obtain the ratio of the distortion components beyond secondary distortion component, {B3/(B1+B2)}×100% was calculated, which is shown in Table 1.

Modulation means signal output variations of the preamble signals (AGC) in the respective sectors of the servo signal transferred to the slave medium through magnetic transfer when read by a magnetic head. For example, if the maximum and minimum signal amplitudes obtained by the oscilloscope are “a” and “b” respectively, the modulation (Mod) is expressed as, Mod={(a−b)/(a+B)}×100 (%) . In the modulation evaluation test, Guzik 1601 and the evaluator available from KYODO DENSHI SYSTEM Corp. were used.

TABLE 1

| | Distortion | Warp | {B3/(B1 + B2) } × | Mod. |
|---|---|---|---|---|
| | (μm) | (μm) | 100 (%) | (%) |
| Example 1 | 31 | 23 | 17.6 | 4 |
| Example 2 | 69 | 33 | 11.9 | 5 |
| Example 3 | 70 | 150 | 4.7 | 5 |
| Comp. Exam 1 | 121 | 48 | 10.8 | 10 |
| Comp. Exam 2 | 56 | 219 | 33.1 | 10 |
| Comp. Exam 3 | 40 | 38 | 50.5 | 10 |

As described above, displacement in height along one rotation of Example 1 is predominated by the primary component. In addition, Example 1 has low distortion and modulation values as shown in Table 1, which means a satisfactory magnetic transfer was enabled by Example 1. Example 2 and Example 3 have grater distortion and warp values, but have smaller values of high-order components and modulation than Example 1, which also means that satisfactory magnetic transfers were enabled by Example 1 and Example 2.

In contrast, Comparative Example 1 has a greater distortion value that exceeds 70 μm, causing increased modulation, which means that the magnetic transfer using Comparative Example 1 was unsatisfactory. Comparative Example 2 has a greater warp value that exceeds 150 μm, causing increased modulation, which means that the magnetic transfer using Comparative Example 2 was unsatisfactory. Comparative Example 3 has a smaller distortion value which is less than 70 μm, but has a higher ratio of high-order components that exceeds 20%, causing increased modulation, which means that the magnetic transfer using Comparative Example 3 was also unsatisfactory.

The test results show that if a magnetic transfer is performed using a master base plate or master substrate with the distortion along one rotation at any equidistance radius (surface defection amount) of less than or equal to 70 μm, warp amount of less than or equal to 150 μm, and the ratio of high-order distortion components of less than or equal to 20%, then the output signal variation (variation in signal amplitude or modulation) per a single track on a slave medium that has received magnetic transfer is less than or equal to 5%. This is a sufficient quality of magnetic transfer that does not affect, for example, servo following capability.

It is noted that there is a case in which the amount of distortion of the master substrate may be reduced when placed on a slave medium in close contact, depending on the ratio of the periodic components of the distortion even if it has a large amount of distortion. For example, peeling a metal disk off the original disk from one direction may reduce the distortion components beyond secondary distortion component. Larger amount of distortion components beyond secondary distortion component is undesirable, because it is likely to develop a gap even if the pressure for contacting the master plate and slave medium is increased. By contrast, distortion components that do not exceed secondary distortion component may be reduced to a certain degree by increasing contacting pressure.

The primary distortion component of the distortion components described above is the displacement in height along one rotation at an equidistance radius, which goes up once and then goes down. Secondary distortion component and beyond are displacements in height that ripple along one rotation at an equidistance radius. Secondary distortion component goes up twice, and third distortion component goes up three times along one rotation at an equidistance radius. In the same manner, fourth distortion component and beyond are displacements in height that ripple, going up four times or more. In reality, there may be a case in which secondary distortion component is superimposed on primary distortion component or a plurality of distortion components is superimposed, constituting the total amount.

1. A magnetic transfer master substrate, comprising:
a master base plate made of a metal having thereon an irregular pattern corresponding to information to be transferred; and
a magnetic layer formed on said irregular pattern, wherein the amount of distortion along one rotation at any equidistance radius of said master base plate is less than or equal to 70 μm.

2. The magnetic transfer master substrate according to claim 1, wherein in said amount of distortion along one rotation at any equidistance radius of said master base plate, the ratio of distortion components beyond secondary distortion component is less than or equal to 20%.

3. The magnetic transfer master substrate according to claim 1, wherein the amount of warp of said master base plate is less than or equal to 150 μm.

4. The magnetic transfer master substrate according to claim 2, wherein the amount of warp of said master base plate is less than or equal to 150 μm.

5. The magnetic transfer master substrate according to claim 1, wherein said master base plate comprises an electroformed Ni layer.

6. The magnetic transfer master substrate according to claim 2, wherein said master base plate comprises an electroformed Ni layer.

7. The magnetic transfer master substrate according to claim 3, wherein said master base plate comprises an electroformed Ni layer.

8. The magnetic transfer master substrate according to claim 4, wherein said master base plate comprises an electroformed Ni layer.

9. A magnetic transfer apparatus, comprising the magnetic transfer master substrate according to any one of claims 1 to 4, wherein information carried by said master substrate is transferred to a slave medium, which is a magnetic recording medium, by placing said master substrate and said magnetic recording medium together such that the surface of said master substrate contacts closely with said magnetic recording medium, and applying a transferring magnetic field thereto.

10. A magnetic transfer apparatus, comprising the magnetic transfer master substrate according to claim 2,
wherein information carried by said master substrate is transferred to a slave medium, which is a magnetic recording medium, by placing said master substrate and said magnetic recording medium together such that the surface of said master substrate contacts closely with said magnetic recording medium, and applying a transferring magnetic field thereto.

11. A magnetic transfer apparatus, comprising the magnetic transfer master substrate according to claim 3,
wherein information carried by said master substrate is transferred to a slave medium, which is a magnetic recording medium, by placing said master substrate and said magnetic recording medium together such that the surface of said master substrate contacts closely with said magnetic recording medium, and applying a transferring magnetic field thereto.

12. A magnetic transfer apparatus, comprising the magnetic transfer master substrate according to claim 4,
wherein information carried by said master substrate is transferred to a slave medium, which is a magnetic recording medium, by placing said master substrate and said magnetic recording medium together such that the surface of said master substrate contacts closely with said magnetic recording medium, and applying a transferring magnetic field thereto.

13. A magnetic transfer apparatus, comprising the magnetic transfer master substrate according to claim 5,
wherein information carried by said master substrate is transferred to a slave medium, which is a magnetic recording medium, by placing said master substrate and said magnetic recording medium together such that the surface of said master substrate contacts closely with said magnetic recording medium, and applying a transferring magnetic field thereto.

14. A magnetic transfer apparatus, comprising the magnetic transfer master substrate according to claim 6,
wherein information carried by said master substrate is transferred to a slave medium, which is a magnetic recording medium, by placing said master substrate and said magnetic recording medium together such that the surface of said master substrate contacts closely with said magnetic recording medium, and applying a transferring magnetic field thereto.

15. A magnetic transfer method using the master substrate according to any one of claims 1 to 4 and the magnetic transfer apparatus according to claim 9,
wherein information carried by said master substrate is transferred to a slave medium, which is a magnetic recording medium, by placing said magnetic recording medium and said master substrate together in close contact with each other, and applying a transferring magnetic field thereto.

16. A magnetic transfer method using the master substrate according to claim 2 and the magnetic transfer apparatus according to claim 9,
wherein information carried by said master substrate is transferred to a slave medium, which is a magnetic recording medium, by placing said magnetic recording medium and said master substrate together in close contact with each other, and applying a transferring magnetic field thereto.

17. A magnetic transfer method using the master substrate according to claim 3 and the magnetic transfer apparatus according to claim 9,
wherein information carried by said master substrate is transferred to a slave medium, which is a magnetic recording medium, by placing said magnetic recording medium and said master substrate together in close contact with each other, and applying a transferring magnetic field thereto.

18. A magnetic transfer method using the master substrate according to claim 4 and the magnetic transfer apparatus according to claim 9,
wherein information carried by said master substrate is transferred to a slave medium, which is a magnetic recording medium, by placing said magnetic recording medium and said master substrate together in close contact with each other, and applying a transferring magnetic field thereto.

19. A magnetic transfer method using the master substrate according to claim 5 and the magnetic transfer apparatus according to claim 9,
wherein information carried by said master substrate is transferred to a slave medium, which is a magnetic recording medium, by placing said magnetic recording medium and said master substrate together in close contact with each other, and applying a transferring magnetic field thereto.

20. A magnetic transfer method using the master substrate according to claim 6 and the magnetic transfer apparatus according to claim 9,
wherein information carried by said master substrate is transferred to a slave medium, which is a magnetic recording medium, by placing said magnetic recording medium and said master substrate together in close contact with each other, and applying a transferring magnetic field thereto.
